(19) United States
(12) Patent Application Publication
(10) Pub. No.: US 2023/0352966 A1
(43) Pub. Date: Nov. 2, 2023

(54) Solar Panel Mobile Device Assembly

(71) Applicant: Hagop Donigian, Mission Hills, CA (US)

(72) Inventor: Hagop Donigian, Mission Hills, CA (US)

(21) Appl. No.: 17/730,328

(22) Filed: Apr. 27, 2022

(51) Int. Cl. H02J 7/35; H02S 40/38; H02J 7/00; H02S 10/40

(52) U.S. Cl. CPC H02J 7/35; H02S 40/38; H02J 7/0042; H02S 10/40; H02J 2300/24

(57) ABSTRACT

A solar panel mobile device assembly for a Smartphone includes a phone being a Smartphone. The phone has a peripheral surface and a back surface positioned parallel relative to each other. The peripheral surface has a screen. A rechargeable battery is positioned within an interior of the phone. A plurality of solar panels is positioned on the peripheral surface and the back surface of the phone. The plurality of solar panels is in electric communication with the battery. Furthermore, a processor is positioned within the interior of the phone.

### CROSS-REFERENCE TO RELATED APPLICATIONS

Not Applicable

### STATEMENT REGARDING FEDERALLY SPONSORED RESEARCH OR DEVELOPMENT

Not Applicable

THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to solar panel phone devices and more particularly pertains to a new solar panel phone device for a Smartphone.

### (2) Description of Related Art Including Information Disclosed Under 37 CFR 1.97 and 1.98

The prior art relates to solar panel phone devices. The prior art relates to a variety of solar panel phone devices having either a single panel or a plurality of panels to charge the phone. Furthermore, the prior art includes a variety of solar panel phone devices configured for a Smartphone. Known prior art lacks a solar panel phone device configured for a Smartphone and having a plurality of panels positioned on the back surface and behind the screen of the device.

### BRIEF SUMMARY OF THE INVENTION

An embodiment of the disclosure meets the needs presented above by generally comprising a phone configured for being a Smartphone. The phone has a peripheral surface and a back surface being positioned parallel relative to each other. The peripheral surface has a screen. In addition, the phone has an interior. A battery is rechargeable and is positioned within the interior of the phone. A plurality of solar panels is positioned on the peripheral surface and the back surface of the phone. The plurality of solar panels is in electric communication with the battery. Furthermore, a processor is positioned within the interior of the phone.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a bottom isometric view of a solar panel mobile device assembly according to an embodiment of the disclosure.

FIG. 2 is a front view of an embodiment of the disclosure.

FIG. 3 is a front view of an alternative embodiment of the disclosure.

FIG. 4 is a back view of an embodiment of the disclosure.

FIG. 5 is an isometric view of an alternative embodiment of the disclosure.

FIG. 6 is a block diagram view of an embodiment of the disclosure.

### DETAILED DESCRIPTION OF THE INVENTION

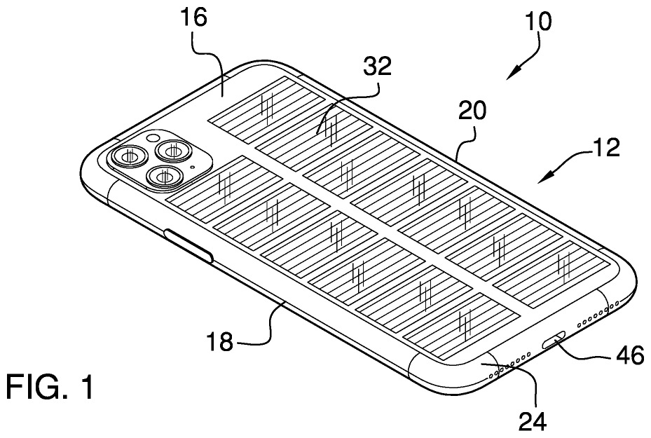

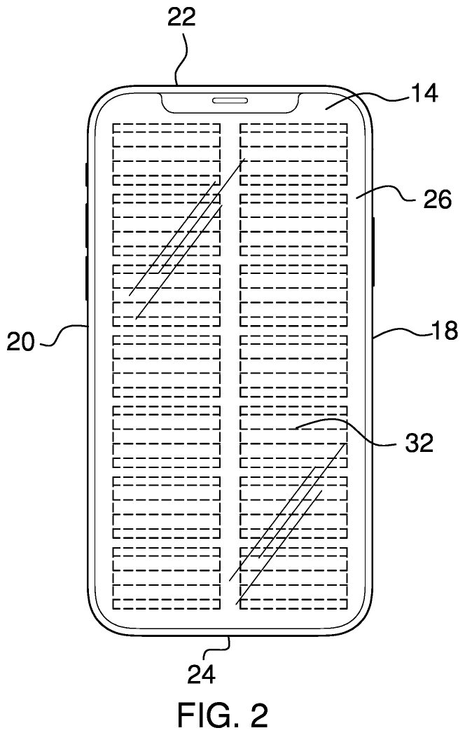

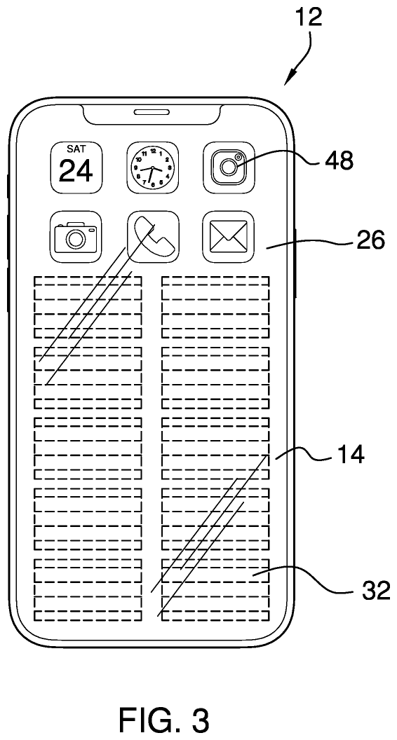

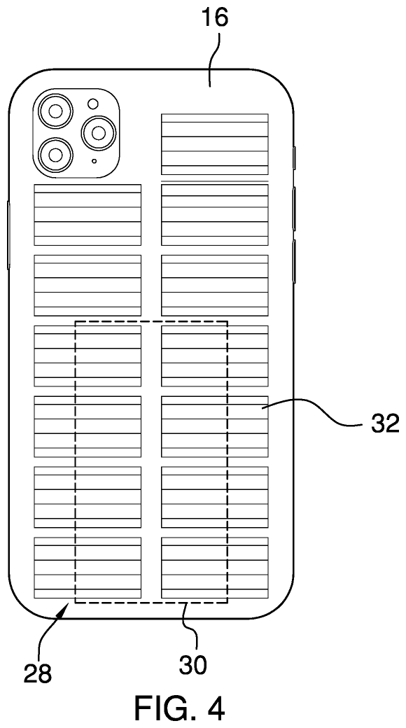

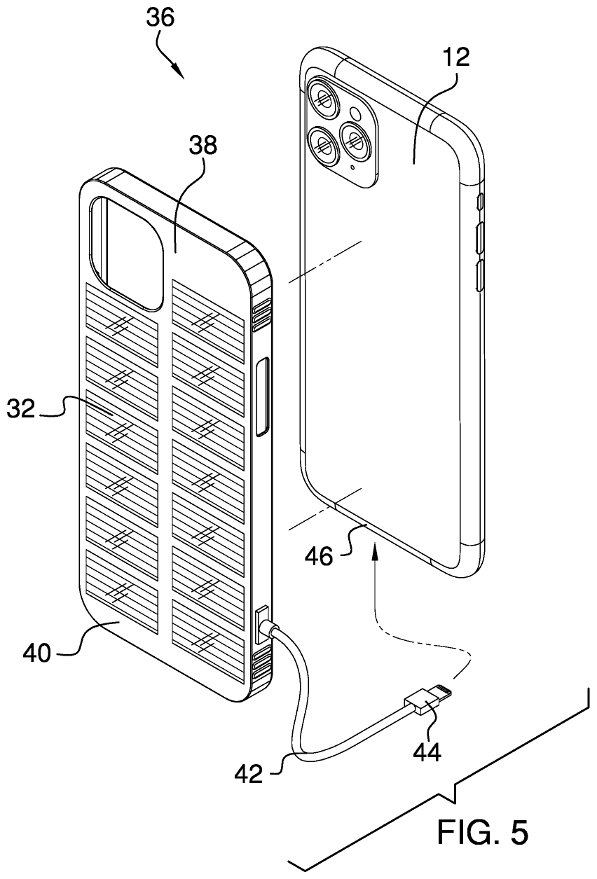

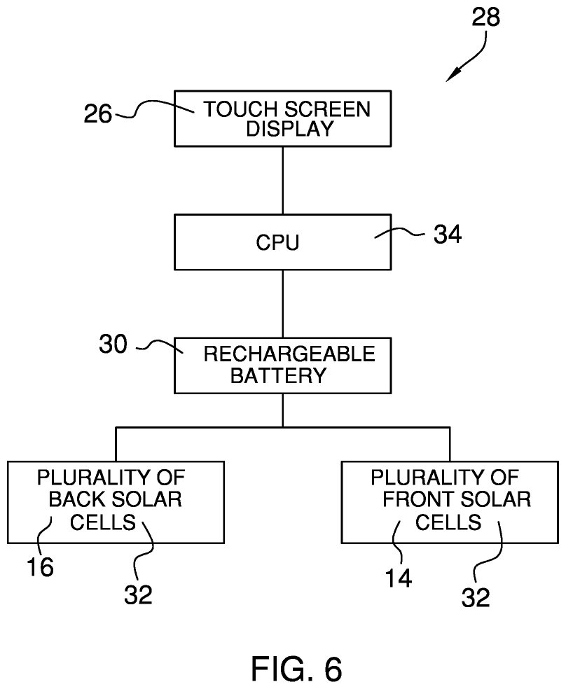

With reference now to the drawings, and in particular to FIGS. 1 through 6 thereof, a new solar panel phone device embodying the principles and concepts of an embodiment of the disclosure and generally designated by the reference numeral 10 will be described.

As best illustrated in FIGS. 1 through 6, the solar panel mobile device assembly 10 generally comprises a phone 12. The phone 12 is configured for being a Smartphone. The phone 12 has a peripheral surface 14 and a back surface 16 being positioned parallel relative to each other. Additionally, the phone has a left surface 18 and a right surface 20 positioned parallel relative to each other. A top surface 22 and a bottom surface 24 are positioned parallel relative to each other. The peripheral 14 and back 16 surfaces are positioned perpendicular relative to the left 18 and right 20 surfaces. Furthermore, the peripheral 14 and back 16 surfaces are positioned perpendicular relative to the top 22 and bottom 24 surfaces as well. A screen 26 in positioned on the peripheral surface 14 of the phone 12. The screen is configured for having digital touch screen capabilities.

The phone 12 has an interior 28 that defines a space for a variety of elements to be stored within. Positioned within the interior 28 of the phone 12 is a battery 30. The battery 30 is rechargeable and is configured for providing power to the phone 12. A plurality of solar panels 32 is in electric communication with the battery 30. The plurality of solar panels 32 is positioned on the peripheral surface 14 and the back surface 16 of the phone 12. On the peripheral surface 14 of the phone 12, the plurality of solar panels 32 is positioned between the screen 26 and the interior 28 of the phone 12.

A processor 34 is positioned within the interior 28 of the phone 12. The processor 34 is a central processing unit and is configured for rendering data of the phone 12. The processor 34 is in communication with the battery 30 and the screen 26 such that the processor 34 receives power from the battery 30 to operate the screen 26 of the phone 12.

An alternate embodiment 36 of the solar panel mobile device assembly 10 comprises a phone case 38 having the plurality of solar panels 32. The phone 12 would be nested within the phone case 38, exposing the peripheral surface 14 of the phone 12. The plurality of solar panels 32 would be positioned on a rear surface 40 of the phone case 38. The plurality of solar panels 32 would be in electric communication with a cord 42. The cord 42 protrudes out from the phone case 38 and has an input 44. The input 44 of the cord 42 is configured for infixing into a port 46 positioned on the bottom surface 24 of the phone 12 whereby providing power to the phone 12.

In use, the plurality of solar panels 32 of the phone 12 would be positioned in sunlight or natural light. The light would be used to produce electric current within each of the solar panels 32 to be sent to the battery 30 of the phone 12. The battery 30 would receive the electric current to provide electric power to the phone 12. The plurality of solar panels 32 on the peripheral surface 14 of the phone 12 would be hidden when the processor 34 displays operations 48 on the screen 26. The alternate embodiment 36 would include nesting the phone 12 within the phone case 38 and positioning the rear surface 40 of the phone case 38 in light to obtain electric current. The electric current would be sent through the cord 42 into the port 46 of the phone 12 to the battery 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A solar powered mobile device configured for powering from a plurality of solar panels, the device comprises:
a phone being configured for being a Smartphone, the phone having a peripheral surface and a back surface being positioned parallel relative to each other, the peripheral surface having a screen, the phone having an interior;
a battery being rechargeable, the battery being positioned within the interior of the phone;
a plurality of solar panels being positioned on the peripheral surface and the back surface of the phone, the plurality of solar panels being in electric communication with the battery; and
a processor being positioned within the interior of the phone.

2. The solar powered mobile device of claim 1, further comprising the phone having a right surface and a left surface being positioned parallel relative to each other, the phone having a top surface and a bottom surface being positioned parallel relative to each other.

3. The solar powered mobile device of claim 1, further comprising the screen being configured for having digital touch screen capabilities.

4. The solar powered mobile device of claim 1, further comprising the interior defining a space for a variety of elements to be stored within.

5. The solar powered mobile device of claim 1, further comprising the battery being configured for providing power to the phone.

6. The solar powered mobile device of claim 1, further comprising the plurality of solar panels being positioned between the screen of the front surface and the interior of the phone.

7. The solar powered mobile device of claim 4, further comprising a processor being positioned within the interior of the phone, the processor being a central processing unit, the processor being configured for rendering data of the phone.

8. The solar powered mobile device of claim 2, further comprising an alternate embodiment comprising a phone case having the plurality of solar panels, the plurality of solar panels of the phone case being in electric communication with a cord, the cord protruding out from the phone case, the cord having an input, the input of the cord being configured for nesting within a port positioned on the bottom surface of the phone wherein providing power to the phone.

9. A solar powered mobile device configured for powering from a plurality of solar panels, the device comprises:
a phone being configured for being a Smartphone, the phone having a peripheral surface and a back surface being positioned parallel relative to each other, the phone having a right surface and a left surface being positioned parallel relative to each other, the phone having a top surface and a bottom surface being positioned parallel relative to each other, the peripheral surface having a screen, the screen being configured for having digital touch screen capabilities, the phone having an interior, the interior defining a space for a variety of elements to be stored within;
a battery being rechargeable, the battery being positioned within the interior of the phone, the battery being configured for providing power to the phone;
a plurality of solar panels being positioned on the peripheral surface and the back surface of the phone, the plurality of solar panels being positioned between the screen of the front surface and the interior of the phone, the plurality of solar panels being in electric communication with the battery;
a processor being positioned within the interior of the phone, the processor being a central processing unit, the processor being configured for rendering data of the phone; and
an alternate embodiment comprising a phone case having the plurality of solar panels, the plurality of solar panels of the phone case being in electric communication with a cord, the cord protruding out from the phone case, the cord having an input, the input of the cord being configured for nesting within a port positioned on the bottom surface of the phone wherein providing power to the phone.
